(19) United States
(12) Patent Application Publication
(10) Pub. No.: US 2006/0124067 A1
(43) Pub. Date: Jun. 15, 2006

(54) Hummingbird feeder attachment

(76) Inventor: Virgle Lindon Taylor, Six Mile, SC (US)

Correspondence Address: John B. Hardaway, III;NEXSEN PRUET, LLC, P.O. BOX 10107, Greenville, SC, 29603, US

(21) Appl. No.: 11/007,848

(22) Filed: Dec. 9, 2004

(51) Int. Cl. A01K 7/00

(52) U.S. Cl. 119/72

(57) ABSTRACT

An insect barring hummingbird feeder attachment is easily installed between an existing hummingbird feeder and its support. The attachment includes a bowl for receiving an insect barring liquid and a roof for preventing rain from entering the bowl. The roof is removable to facilitate cleaning the bowl of trapped ants and other insects and to facilitate refilling the bowl with an insect barring liquid.

### BACKGROUND OF THE INVENTION

The hummingbird is one of the most interesting birds and a multitude of bird lovers have special sweet nectar feeding bird feeders for them. Unfortunately ants and other insects are attracted to the nectar and if the nectar is not protected it is soon contaminated by ants and other small crawling insects. This problem has been recognized by others who have incorporated liquid barrier features in hummingbird feeders; however, there are many existing hummingbird feeders, which do not have a liquid barrier to ants and crawling insets. Those hummingbird feeders incorporating a liquid barrier to ants are difficult to service; particularly as to removing trapped insects and replacing barrier liquid.

### SUMMARY OF THE INVENTION

A separate ant blocking attachment is provided for connection above a hanging hummingbird feeder. A bowl is provided for a liquid barrier and a roof is provided above the bowl to prevent rain from entering the bowl. The attachment can easily be removed from the depending hummingbird feeder to permit cleaning the bowl of trapped ants and adding barrier liquid such as oil. The roof can be removed to facilitate cleaning the bowl and to facilitate refilling the bowl. The hummingbird feeder is easily disconnected from the ant blocking attachment to facilitate adding nectar to the feeder. The ant blocking attachment can be added without modification of the existing hummingbird feeder or its support.

### BRIEF DESCRIPTION OF THE DRAWINGS

The invention is illustrated in the drawings in which:

FIG. 1 shows the insect barring attachment and a depending humming bird feeder suspended from a tree limb;

FIG. 2 is a vertical section of the insect barring attachment;

FIG. 3 is a section taken on the line 3-3 in FIG. 1; and

FIG. 4 is a section taken on the line 4-4 in FIG. 1.

### DETAILED DESCRIPTION OF THE INVENTION

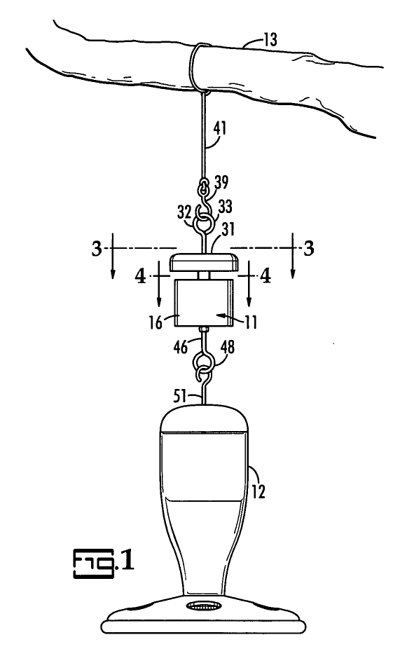

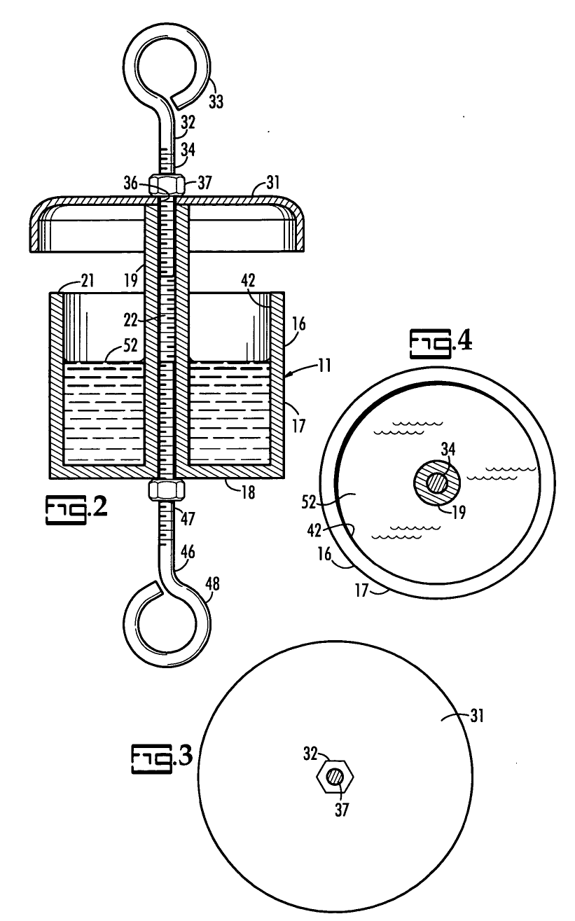

As shown in FIG. 1, the insect blocking hummingbird feeder attachment 11 is interposed between a sweet nectar hummingbird feeder 12 and a support such as a tree limb 13. The insect barring attachment 11 includes a bowl 16 having a cylindrical vertical side wall 17, a horizontal bottom wall 18 and a narrow central vertical column 19 at the center of the bowl 16 secured to the bottom wall 18 and extending vertically upward above the top 21 of the side wall 17. The side wall 17, the column 19 spaced laterally inward from the side wall 17 and the bottom wall 18 define an interior cavity 42. The insect blocking attachment 11 also includes an annular roof 31 mounted on or releasably secured to the column 19 by a connection component in the form of an eye bolt 32 having an eye 33 and a threaded shank 34 extending through a central vertical opening 36 in the roof 31 and threadedly engaging the threaded bore 22 of the column 19. A lock nut 37 on the threaded shank 34 secures the roof 31 against the upper end of the column 19. The eye 33 of the eye bolt 32 is adapted for connection to a hook 39 connected to the lower end of a cord or cable 41, as shown in FIG. 1. The top of the roof 31 extends horizontally outward beyond the side wall 17 of the bowl 16 thereby preventing rain from entering the interior cavity 42 of the bowl 16.

A connection component in the form of an eyebolt 46 on the underside of the bowl 16 has a threaded shank 47 in threaded engagement with the threaded bore 22 in the column 19 and an eye 48 for releasable connection to a support component or hook 51 at the top of a humming bird feeder 12.

In use, the bowl 16 of the feeder attachment 11 is filled with a suitable liquid 52 such as oil, which prevents or bars ants and other small crawling insects from reaching the sweet nectar in the hummingbird feeder 12. During use, a considerable number of ants and other small crawling insects will be entrapped in and die in the liquid 52 and the bowl 16 will need to be emptied and refilled with trapping liquid, such as an oil. The attached 11 may be disconnected from the feeder 12 and from the support hook 39, and the roof 31 may be removed from the bowl 16 to make it easier to clean and to refill the bowl 16.

A relatively inexpensive insect trapping hummingbird feeder attachment 11 is provided which is easily interconnected between a hanging feeder 12 and its support 13. The owner of a humming bird feeder experiencing problems of ants feeding on and dying in the sweet nectar, need not purchase a new feeder with a built in trap for such insects. The purchase and installation of the inexpensive attachment herein described provides an economical solution. The insect barring liquid 52 is protected from the rain by the roof 31, which extends radially outward beyond the cylindrical wall 17 of the bowl 16, and the roof is easily removed to facilitate cleaning and replacement of the trapping liquid.

1. A hummingbird feeder attachment comprising:
a bowl having
a horizontally extending bottom wall,
an annular side wall extending upwardly from the outer edges of said bottom wall, and
a narrow central cylindrical column integral with and extending upwardly from a central part of said bottom wall in laterally inward spaced relation to said cylindrical side wall, said walls and column defining an interior cavity for receiving an insect barring liquid, said central column extending upwardly beyond said side wall,
a roof releaseably mounted in abutting supported relation on the top of said central column and disposed a predetermined distance above said side wall, said roof having a top extending horizontally beyond said side wall to prevent rain from entering said interior cavity,
a connection component at said top of said roof adapted for connection to a support, and
a connection component on the underside of said bottom wall adapted for a supporting connection to a hummingbird feeder.

2. (canceled)

3. (canceled)

4. The hummingbird feeder attachment of claim 1 wherein said roof is releasably connected to said central column.

5. The hummingbird feeder attachment of claim 4 wherein said roof is releasably connected to said central column by a bolt.

6. The hummingbird feeder attachment of claim 5 wherein said bolt has an eye on its upper end constituting said connection component at said top of said roof.

7. The hummingbird feeder attachment of claim 6 wherein said connection component on the underside of said bottom wall is an eye bolt.

8. The hummingbird attachment of claim 1 wherein said side wall is cylindrical and said roof is annular.
